(19) United States
(12) Patent Application Publication
(10) Pub. No.: US 2026/0198599 A1
(43) Pub. Date: Jul. 16, 2026

(54) TERMINAL DEVICE AND INFORMATION PROCESSING DEVICE

(71) Applicant: Japan Tobacco Inc., Tokyo (JP)

(72) Inventor: Manabu YAMADA, Tokyo (JP)

(73) Assignee: Japan Tobacco Inc., Tokyo (JP)

(21) Appl. No.: 19/136,298

(22) PCT Filed: Dec. 13, 2022
(86) PCT No.: PCT/JP2022/045792

§ 371 Date: Jun. 6, 2025

(51) Int. Cl. A24F 40/57; A24F 40/65

(52) U.S. Cl. CPC A24F 40/57; A24F 40/65

(57) ABSTRACT

A terminal device including a control unit that controls processing for: setting, on the basis of information regarding generation of an aerosol acquired from an inhalation device that heats an aerosol source contained in a substrate to generate an aerosol, an evaluation period during which a smoking taste evaluation for the aerosol generated by the inhalation device can be set; and receiving the setting for a smoking taste evaluation by a user during the set evaluation period.

### TECHNICAL FIELD

The present invention relates to a terminal device and an information processing device.

### BACKGROUND ART

Inhalation devices that generate substances to be inhaled by a user, such as e-cigarettes and nebulizers, are in widespread use. For example, an inhalation device employs an aerosol source for generating an aerosol, and a substrate including a flavor source or the like for imparting a flavor component to the generated aerosol, to generate an aerosol to which the flavor component has been imparted. The user can enjoy the flavor by inhaling the aerosol to which the flavor component has been imparted, generated by the inhalation device. The action by which the user inhales the aerosol is also referred to below as “puffing” or a “puffing action”.

There is a need to further improve the flavor (also referred to below as the “smoking taste”) which the user enjoys when puffing on the inhalation device. For example, PTL 1 below describes the feature of a substrate capable of improving the smoking taste. PTL 1 below further indicates that the smoking taste is evaluated in several examples of substrates.

### CITATION LIST

### Patent Literature

PTL 1 JP 6839181 B2

### SUMMARY OF INVENTION

### Technical Problem

However, in the above PTL 1, a dedicated device was used in the laboratory, and the smoking taste was evaluated by limited evaluators.

Accordingly, the present disclosure takes account of the abovementioned problem, and the objective of the present disclosure lies in providing an arrangement that enables a smoking taste evaluation to be performed more easily.

### Solution to Problem

In order to solve the above problem, one aspect of the present invention provides a terminal device comprising a control unit that controls processing for: setting, on the basis of information regarding generation of an aerosol acquired from an inhalation device that heats an aerosol source contained in a substrate to generate an aerosol, an evaluation period during which a smoking taste evaluation for the aerosol generated by the inhalation device can be set; and receiving the setting for smoking taste evaluation by a user during the evaluation period which has been set.

The control unit may set the evaluation period within a period during which the inhalation device generates the aerosol by using one of the substrates.

The control unit may set a plurality of the evaluation periods, and each of the plurality of evaluation periods may correspond to each of a plurality of timings at which the aerosol generated by the inhalation device is inhaled by the user.

The inhalation device may heat the aerosol source on the basis of control information defining a parameter relating to a temperature at which the aerosol source is heated, and the information regarding generation of the aerosol may include information for identifying the control information used by the inhalation device.

The control unit may control processing for storing a combination of information for identifying the control information used by the inhalation device and information indicating a smoking taste evaluation which has been set.

The information regarding generation of the aerosol may include information indicating that heating of the aerosol source has been started, and the control unit may set the evaluation period on the basis of time elapsed since the start of heating of the aerosol source.

The control unit may control processing for notifying the user of information indicating that the timing to inhale the aerosol generated by the inhalation device has been reached.

The information regarding generation of the aerosol may include information indicating that the aerosol generated by the inhalation device has been inhaled, and the control unit may set the evaluation period after a timing at which the aerosol generated by the inhalation device has been inhaled.

The control unit may control processing for notifying the user of information indicating the progress of processing in which the inhalation device generates the aerosol.

The control unit may receive the setting for smoking taste evaluation for a plurality of evaluation items in one of the evaluation periods.

The control unit may control processing for notifying the user of information indicating a smoking taste evaluation which has been set.

Furthermore, in order to solve the above problem, another aspect of the present invention provides an information processing device comprising: a communication unit that receives evaluation result information including a smoking taste evaluation set by a user for an aerosol generated by an inhalation device heating an aerosol source contained in a substrate on the basis of control information defining a parameter relating to a temperature at which the aerosol source is heated; and a control unit that aggregates a plurality of pieces of the evaluation result information including smoking taste evaluations set by the user for the aerosol generated on the basis of the same control information, received by the communication unit.

The control unit may aggregate a plurality of pieces of the evaluation result information including smoking taste evaluations set by a plurality of users.

The control unit may aggregate a plurality of pieces of the evaluation result information including smoking taste evaluations set by a plurality of users belonging to a prescribed user group or set in a prescribed environment.

The control unit may aggregate a plurality of pieces of the evaluation result information including smoking taste evaluations set by the user for the aerosol generated by using the same type of substrate.

### Advantageous Effects of Invention

The present disclosure as described above provides an arrangement that enables a smoking taste evaluation to be performed more easily.

### BRIEF DESCRIPTION OF DRAWINGS

FIG. 1 is a view showing a configuration example of a system according to the present embodiment.

FIG. 2 is a schematic diagram schematically illustrating a configuration example of an inhalation device.

FIG. 3 is a block diagram showing a configuration example of a terminal device according to the embodiment.

FIG. 4 is a block diagram showing a configuration example of a server according to the present embodiment.

FIG. 5 is a graph schematically showing an example of a heating profile.

FIG. 6 is a diagram showing an example of a UI screen displayed by the terminal device according to the embodiment.

FIG. 7 is a sequence chart showing an example of a processing flow implemented by the system according to the present embodiment.

### DESCRIPTION OF EMBODIMENTS

Preferred embodiments of the present disclosure will now be described in detail with reference to the accompanying drawings. It should be noted that in the specification and the drawings, duplicate descriptions are omitted by using the same reference signs to denote constituent elements having substantially the same functional configuration.

### 1. Configuration Example

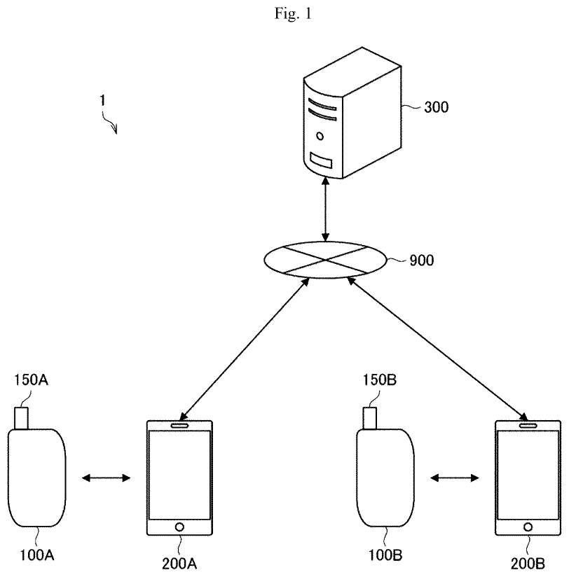

FIG. 1 is a view showing a configuration example of a system 1 according to an embodiment of the present disclosure. As shown in FIG. 1, the system 1 includes a plurality of inhalation devices 100 (100A and 100B), a plurality of terminals (200A and 200B), and a server 300.

The inhalation device 100 is a device for generating a substance to be inhaled by a user. Hereinafter, the substance generated by the inhalation device 100 will be described as being an aerosol. The inhalation device 100 is an example of an aerosol generating device that generates an aerosol. Alternatively, the substance generated by the inhalation device 100 may be a gas. The inhalation device 100 can accommodate a stick-type substrate 150. The inhalation device 100 generates the aerosol by using the stick-type substrate 150 accommodated therein. The stick-type substrate 150 is an example of a substrate that contributes to generation of an aerosol. The stick-type substrate 150 contains an aerosol source. The inhalation device 100 generates the aerosol by heating the stick-type substrate 150 accommodated therein.

The terminal device 200 is a device used by a user of the inhalation device 100. The terminal device 200 is associated with the inhalation device 100. The inhalation device 100 and the terminal device 200 may be paired in advance for wireless communication, or the fact that the user of the inhalation device 100 and the terminal device 200 is the same may be registered in the server 300 in advance. The terminal device 200 may be any device such as a smartphone, a tablet terminal, a wearable device, or a personal computer (PC). Alternatively, the terminal device 200 may be a charger that charges the inhalation device 100.

The server 300 is an information processing device that manages information about each device included in the system 1. The server 300 is connected to the monitoring device 200 via a network 900. In particular, the server 300 indirectly communicates with the inhalation device 100 via the terminal device 200. The server 300 may perform various processing on the basis of information collected from the inhalation device 100 via the terminal device 200. Alternatively, the server 300 may perform various processing on the basis of user operations performed on the terminal device 200.

The system 1 includes a plurality of the inhalation devices 100 and a plurality of the terminal devices 200 used by a plurality of users. As an example, a user who uses the inhalation device 100A and the terminal device 200A is also referred to as user A. A user who uses the inhalation device 100B and the terminal device 200B is also referred to as user B.

### (1) Configuration Example of Inhalation Device

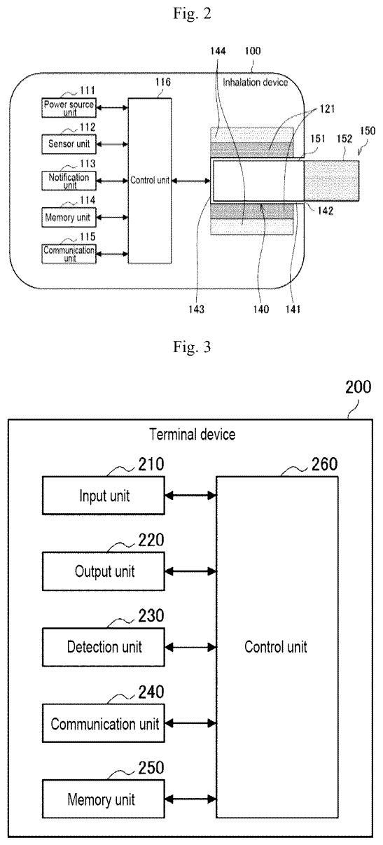

FIG. 2 is a schematic diagram illustrating schematically a configuration example of the inhalation device 100. As illustrated in FIG. 2, an inhalation device 100 according to the present configuration example comprises a power source unit 111, a sensor unit 112, a notification unit 113, a memory unit 114, a communication unit 115, a control unit 116, heating units 121, an accommodating portion 140, and a heat insulating portion 144.

The power source unit 111 stores electric power. The power source unit 111 then supplies the electric power to each component of the inhalation device 100 in accordance with control performed by the control unit 116. The power source unit 111 may be configured, for example, by a rechargeable battery such as a lithium ion secondary battery.

The sensor unit 112 acquires various types of information relating to the inhalation device 100. As an example, the sensor unit 112 is configured by a pressure sensor such as a condenser microphone, a flow rate sensor or a temperature sensor, etc., and acquires values associated with inhalation by a user. As another example, the sensor unit 112 is configured by an input device, such as a button or switch, for accepting input of information from the user.

The notification unit 113 notifies the user of the information. The notification unit 113 is configured by a light emitting device that emits light, a display device that displays images, a sound output device that outputs sound, or a vibrating device that vibrates, for example.

The memory unit 114 stores various types of information for the operation of the inhalation device 100. The memory unit 114 is configured by a non-volatile storage medium such as a flash memory, for example.

The communication unit 115 is a communication interface capable of performing communication conforming to any wired or wireless communication standard. Examples of communication standards that may be used include standards that employ Wi-Fi (registered trademark), Bluetooth (registered trademark), BLE (Bluetooth Low Energy) (registered trademark), NFC (Near-Field Communication), or LPWA (Low Power Wide Area), for example.

The control unit 116 functions as an arithmetic processing device and a control device, and controls overall operation within the inhalation device 100 in accordance with various programs. The control unit 116 is realized by a CPU (Central Processing Unit) or an electronic circuit such as a microprocessor, for example.

The accommodating portion 140 has an internal space 141, and holds a stick-shaped substrate 150 while accommodating a portion of the stick-shaped substrate 150 in the internal space 141. The accommodating portion 140 has an opening 142 allowing the internal space 141 to communicate with the outside, and accommodates the stick-type substrate 150 that has been inserted into the internal space 141 from the opening 142. For example, the accommodating portion 140 is a cylindrical body comprising the opening 142 and a bottom portion 143 serving as a bottom surface, and defines the columnar internal space 141. An air flow path for supplying air to the internal space 141 is connected to the accommodating portion 140. An air inflow hole, which is an inlet for air into the air flow path, is disposed in a side surface of the inhalation device 100, for example. An air outflow hole serving as an outlet for air from the air flow path to the internal space 141 is disposed in the bottom portion 143, for example.

The stick-type substrate 150 comprises a substrate portion 151 and a mouthpiece portion 152. The substrate portion 151 contains an aerosol source. The aerosol source includes a tobacco-derived or non-tobacco-derived flavor component. If the inhalation device 100 is a medical inhaler such as a nebulizer, the aerosol source may include a drug. The aerosol source may, for example, be a liquid such as water or a polyhydric alcohol, for example glycerol or propylene glycol, containing the tobacco-derived or non-tobacco-derived flavor component, or may be a solid including the tobacco-derived or non-tobacco-derived flavor component. In a state in which the stick-type substrate 150 is being held in the accommodating portion 140, at least a portion of the substrate portion 151 is accommodated in the internal space 141, and at least a portion of the mouthpiece portion 152 protrudes from the opening 142. Then, when the user holds the mouthpiece portion 152 protruding from the opening 142 in their mouth and inhales, air flows into the internal space 141 via the air flow path, which is not illustrated in the drawings, and reaches the inside of the user's mouth together with the aerosol generated from the substrate portion 151.

The heating units 121 heat the aerosol source to atomize the aerosol source, thereby generating the aerosol. In the example illustrated in FIG. 2, the heating units 121 are configured in a film shape and are disposed so as to cover the outer periphery of the accommodating portion 140. Then, when the heating units 121 generate heat, the substrate portion 151 of the stick-type substrate 150 is heated from the outer periphery, generating the aerosol. The heating units 121 generate heat when supplied with electricity from the power source unit 111. By way of example, electricity may be supplied when the sensor unit 112 detects that the user has started inhaling and/or that predetermined information has been input. The supply of electricity may then be stopped when the sensor unit 112 detects that the user has finished inhaling and/or that predetermined information has been input.

The heat insulating portion 144 prevents heat transfer from the heating unit 121 to other components. For example, the heat insulating portion 144 is configured from a vacuum heat insulating material or an aerogel heat insulating material, or the like.

A configuration example of the inhalation device 100 has been described above. The inhalation device 100 is, of course, not limited to the configuration described above, and may adopt various configurations, such as those illustrated below by way of example.

As one example, the heating unit 121 may have a blade-like form and may be arranged so as to protrude into the internal space 141 from the bottom portion 143 of the accommodating portion 140. In that case, the blade-like heating unit 121 is inserted into the substrate portion 151 of the stick-type substrate 150 and heats the substrate portion 151 of the stick-type substrate 150 from the inside. As another example, the heating unit 121 may be arranged so as to cover the bottom portion 143 of the accommodating portion 140. Furthermore, the heating unit 121 may be configured by a combination of two or more from among a first heating unit covering the outer circumference of the accommodating portion 140, a blade-like second heating unit, and a third heating unit covering the bottom portion 143 of the accommodating portion 140.

As another example, the accommodating portion 140 may comprise an opening/closing mechanism such as a hinge for opening/closing part of a casing that forms the internal space 141. By opening/closing the casing, the accommodating portion 140 may then receive and grip the stick-type substrate 150 which has been inserted into the internal space 141. In that case, the heating units 121 may be provided on the part of the accommodating portion 140 gripping the stick-type substrate 150, and may heat the stick-type substrate 150 while pressing the same.

Furthermore, the means for atomizing the aerosol source is not limited to heating provided by the heating units 121. For example, the means for atomizing the aerosol source may be induction heating. In that case, the inhalation device 100 comprises at least an electromagnetic induction source such as a coil for generating a magnetic field, instead of the heating units 121. A susceptor which generates heat by means of induction heating may be provided in the inhalation device 100, or may be contained in the stick-type substrate 150.

It should be noted that the inhalation device 100 collaborates with the stick-type substrate 150 to generate an aerosol to be inhaled by the user. As such, the combination of the inhalation device 100 and the stick-type substrate 150 may be considered as an aerosol-generating system.

### (2) Configuration Example of Terminal Device

FIG. 3 is a block diagram showing a configuration example of the terminal device 200 according to the embodiment. As shown in FIG. 3, the terminal device 200 includes an input unit 210, an output unit 220, a detection unit 230, a communication unit 240, a memory unit 250, and a control unit 260.

The input unit 210 has the function of accepting input of various information. Furthermore, the input unit 210 may include an input device, such as a button or a switch, for accepting input of information from the user. Examples of input devices that may be cited include a button, a keyboard, a touch panel, and a microphone, etc. Alternatively, the input unit 210 may include various types of sensors such as an image sensor.

The output unit 220 has the function of outputting information. The output unit 220 may include an output device that outputs information to the user. Examples of output devices that may be cited include: a display device for displaying information, a light-emitting device for emitting light, a vibration device which vibrates, and a sound output device for outputting sound, etc. A display is an example of the display device. A light-emitting diode (LED) is an example of the light-emitting device. An eccentric motor is an example of the vibration device. A speaker is an example of the sound output device. The output unit 220 outputs the information input from the control unit 260 to notify the user of the information.

The detection unit 230 has the function of detecting information relating to the terminal device 200. The detection unit 230 may detect location information of the terminal device 200. For example, the detection unit 230 receives a GNSS (global navigation satellite system) signal from a GNSS satellite (e.g., a GPS signal from a GPS (global positioning system) satellite), and detects location information comprising the longitude and latitude of the device. The detection unit 230 may detect movement of the terminal device 200. For example, the detection unit 230 includes a gyro sensor and an acceleration sensor, and detects an angular velocity and an acceleration.

The communication unit 240 is a communication interface for sending and receiving information between the terminal device 200 and another device. The communication unit 240 performs communication conforming to any wired or wireless communication standard. Examples of communication standards which may be used include standards employing USB (universal serial bus), Wi-Fi (registered trademark), Bluetooth (registered trademark), NFC (near field communication), or LPWA (low-power wide area), etc.

The memory unit 250 stores various types of information. The memory unit 250 is configured by a non-volatile storage medium such as a flash memory, for example.

The control unit 260 functions as an arithmetic processing device or a control device, controlling overall operation within the terminal device 200 in accordance with various programs. The control unit 260 is realized by a CPU (central processing unit) or an electronic circuit such as a microprocessor, for example. The control unit 260 may also include a ROM (read-only memory) for storing programs and computation parameters, etc. which are used, and a RAM (random access memory) for temporarily storing suitably modifying parameters, etc. The terminal device 200 implements various types of processing based on control performed by the control unit 260. Examples of processing controlled by the control unit 260 include: processing of information input by means of the input unit 210, output of information by the output unit 220, detection of information by the detection unit 230, sending and receiving of information by the communication unit 240, and storage/reading of information by the memory unit 250. Other processing implemented by the terminal device 200, such as processing based on input of information to each component and information output from each component, are also controlled by means of the control unit 260.

It should be noted that the functions of the control unit 260 may be realized using an application. The application may be pre-installed or downloaded. Furthermore, the functions of the control unit 260 may be realized by means of PWA (progressive web apps).

### (3) Configuration Example of Server

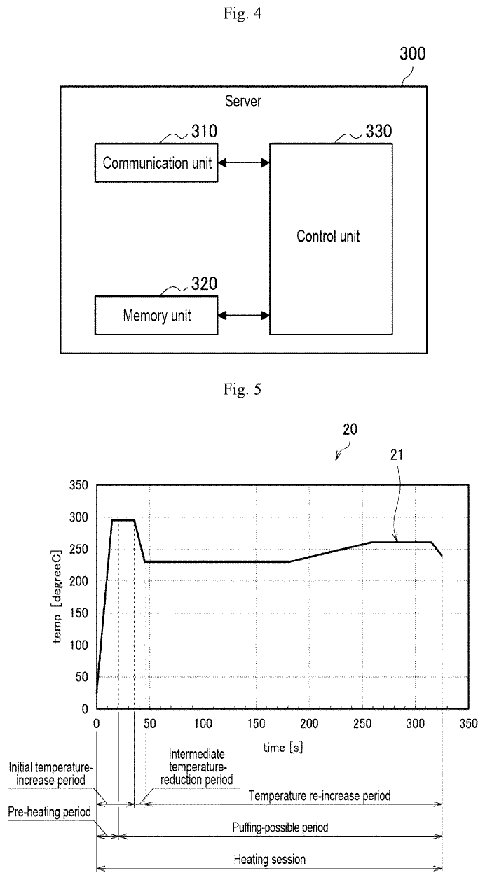

FIG. 4 is a block diagram showing a configuration example of the server 300 according to the present embodiment. As shown in FIG. 4, the server 300 includes a notification unit 310, a memory unit 320, and a communication unit 330.

The communication unit 310 is a communication interface for sending and receiving information between the server 300 and another device. The communication unit 310 performs communication conforming to any wired or wireless communication standard.

The memory unit 320 stores various types of information for operation of the server 300. The memory unit 320 is constructed of a non-volatile storage medium such as, for example, an HDD (Hard Disk Drive) and an SSD (Solid State Driver).

The control unit 330 functions as an arithmetic processing device and a control device, controlling overall operation within the server 300 in accordance with various programs. The control unit 330 is realized by a CPU (Central Processing Unit) and an electronic circuit such as a microprocessor, for example. The control unit 330 may also include a ROM (read-only memory) for storing programs and computation parameters, etc. which are used, and a RAM (random access memory) for temporarily storing suitably changing parameters, etc. The server 300 implements various types of processing on the basis of control performed by the control unit 330. The sending and receiving of information by the communication unit 310, and storage/reading of information by the memory unit 320 are examples of processing controlled by the control unit 330. Other processing implemented by the server 300, such as processing based on input of information to each component and information output from each component, are also controlled by means of the control unit 330.

### 2. Technical Features

### (1) Heating Profile

The control unit 116 controls the operation of the heating units 121 based on the heating profile. Control of the operation of the heating units 121 is achieved by controlling the supply of power from the power source unit 111 to the heating units 121. The heating units 121 heat the stick-type substrate 150 using power supplied from the power source unit 111.

The heating profile is control information for controlling the temperature at which the aerosol source is heated. The heating profile defines a parameter relating to a temperature at which the aerosol source is heated. The temperature of the heating units 121 is an example of the temperature at which the aerosol source is heated. A target value of the temperature of the heating units 121 (also referred to below as the “target temperature”) is an example of a parameter relating to the temperature at which the aerosol source is heated. The temperature of the heating units 121 may be controlled to change in accordance with the time elapsed from the start of heating. In this case, the heating profile includes information defining a time-series transition of the target temperature. As another example, the heating profile may comprise a parameter (hereinafter also referred to as a power supply parameter) defining how power is supplied to the heating units 121. The power supply parameters include, for example, a voltage applied to the heating units 121, ON/OFF of the power supply to the heating units 121, or a method of feedback control to be employed. ON/OFF of the power supply to the heating units 121 may be considered as ON/OFF of the heating units 121.

The control unit 116 controls the operation of the heating units 121 such that the temperature of the heating units 121 (also referred to below as the “actual temperature”) transitions similarly to the target temperature defined in the heating profile. The heating profile is typically designed such that, when the user inhales the aerosol generated from the stick-type substrate 150, the flavor tasted by the user is optimized. Thus, by controlling the operation of the heating units 121 based on the heating profile, the flavor tasted by the user can be optimized.

The temperature control of the heating units 121 can be achieved by known feedback control, for example. The feedback control may be a Proportional-Integral-Differential Controller (PID) control, for example. The control unit 116 may cause power from the power supply unit 111 to be supplied to the heating units 121 in the form of pulses by pulse width modulation (PWM) or pulse frequency modulation (PFM). In that case, the control unit 116 can perform temperature control of the heating units 121 by adjusting the frequency or the duty ratio of the power pulse in feedback control. Alternatively, the control unit 116 may perform simple ON/OFF control in feedback control. For example, the control unit 116 may perform heating by the heating units 121 until the actual temperature reaches the target temperature, interrupt heating by the heating units 121 when the actual temperature reaches the target temperature, and resume heating by the heating units 121 when the actual temperature falls below the target temperature.

The temperature of the heating units 121 can be quantified by measuring or estimating the electrical resistance value of the heating units 121 (a heating resistive element constituting the heating units 121, to be more precise), for example. This is because the electrical resistance of the heating resistive element varies with temperature. The electrical resistance value of the heating resistive element can be estimated by measuring the amount of voltage drop at the heating resistive element, for example. The amount of voltage drop at the heating resistive element can be measured by a voltage sensor measuring a potential difference applied to the heating resistive element. In another example, the temperature of the heating units 121 can be measured by a temperature sensor such as a thermistor installed near the heating units 121.

The period from the start of the process of generating an aerosol using the stick-type substrate 150 to the end is also referred to hereinafter as a heating session. In other words, a heating session is a period of time during which electrical supply to the heating units 121 is controlled on the basis of the heating profile. The beginning of the heating session is the timing at which heating based on the heating profile is started. The end of the heating session is the timing at which a sufficient amount of aerosol is no longer generated. The heating session comprises a first-half pre-heating period and a second-half puffing-possible period. The puffing-possible period is the period of time during which a sufficient amount of aerosol is expected to be generated. The pre-heating period is the period from when heating is started until the puffing-possible period is started. Heating performed in the pre-heating period is also referred to as pre-heating.

The notification unit 113 may notify the user of information indicative of the timing at which the pre-heating ends. For example, the notification unit 113 notifies the user of information announcing the end of the pre-heating period before the pre-heating period ends, or notifies the user of information indicating that the pre-heating has ended at the timing at which the pre-heating has ended. The notification to the user can be by lighting an LED or vibrating, or the like, for example. By referring to such notification, the user is able to take a puff immediately after the end of the pre-heating.

Similarly, the notification unit 113 may notify the user of information indicative of when the puffing-possible period ends. For example, the notification unit 113 notifies the user of information announcing the end of the puffing-possible period before the puffing-possible period ends, or notifies the user of information indicating that the puffing-possible period has ended at the timing at which the puffing-possible period has ended. The notification to the user can be by lighting an LED or vibrating, or the like, for example. By referring to such notification, the user is able to take a puff until the end of the puffing-possible period.

An example of the heating profile will be described with reference to FIG. 5. FIG. 5 is a graph schematically showing an example of a heating profile. The horizontal axis of the graph 20 denotes time. The vertical axis of the graph 20 denotes temperature. The line 21 denotes a time-series transition of the target temperature. As shown in FIG. 5, the heating session may include an initial temperature-increase period, an intermediate temperature-reduction period, and a temperature re-increase period in succession. The initial temperature-increase period is a period in which the temperature of the heating units 121 rapidly rises after the start of heating and is kept at a high temperature. The intermediate temperature-reduction period is a period in which the temperature of the heating units 121 drops after the initial temperature-increase period. The temperature re-increase period is a period in which the temperature of the heating units 121 is once again increased after the intermediate temperature-reduction period. In the example shown in FIG. 5, the target temperature rapidly increases to around 300° C. during the initial temperature-increase period, then drops to around 230° C. during the intermediate temperature-reduction period, after which the temperature increases stepwise to around 260° C. during the temperature re-increase period. During the intermediate temperature-reduction period, electrical supply to the heating units 121 may be interrupted and heating may be turned OFF. In the example shown in FIG. 5, the period from the start of heating to partway through the initial temperature-increase period is the pre-heating period, and the period from partway through the initial temperature-increase period to the end of the temperature re-increase period is the puffing-possible period.

### (2) Setting of Smoking Taste Evaluation

The terminal device 200 (e.g., control unit 260) sets an evaluation period in which evaluation of the smoking taste of the aerosol generated by the inhalation device 100 can be set on the basis of the information regarding generation of the aerosol acquired from the inhalation device 100. For example, the terminal device 200 receives information regarding generation of the aerosol source from the inhalation device 100 and sets the evaluation period based on the received information. The terminal device 200 then controls processing to receive setting of the smoking taste evaluation by the user in the evaluation period which has been set. For example, the terminal device 200 displays, on a touch panel, a UI (user interface) screen for setting the smoking taste evaluation, and receives a touch operation for setting the smoking taste evaluation during the evaluation period. By virtue of this feature, a user can evaluate the smoking taste while using the inhalation device 100. Therefore, it is not necessary to use a dedicated device to evaluate the smoking taste, and the smoking taste evaluation can be collected from a wide range of ordinary users. In this manner, it is possible to more easily evaluate the smoking taste.

The terminal device 200 uses one stick-type substrate 150 to set an evaluation period within a period in which the inhalation device 100 is generating an aerosol. The terminal device 200 sets an evaluation period within the heating session. In particular, it is desirable for the terminal device 200 to set the evaluation period within the puffing-possible period. According to such a configuration, a user can set the evaluation of the smoking taste in real time while puffing during the heating session. Therefore, it is possible to reduce the burden on the user as compared to when a smoking taste evaluation is set after the heating session has terminated. Of course, the terminal device 200 may set the evaluation period after the puffing-possible period ends. In this case, the user can set up the evaluation of the smoking taste calmly.

The terminal device 200 sets a plurality of evaluation periods. In particular, each of the plurality of evaluation periods corresponds to each of a plurality of timings at which the aerosol generated by the inhalation device 100 is inhaled by the user. That is, the terminal device 200 sets one evaluation period for one puff. For example, the terminal device 200 sets, as the evaluation period, a predetermined period including the timing of puffing (hereinafter also referred to as puff timing). By virtue of this feature, the user can set a smoking taste evaluation for each puff immediately after the relevant puff. Accordingly, the user can set a smoking taste evaluation for each puff while it is still fresh in the mind.

The information regarding generation of the aerosol that the terminal device 200 acquires from the inhalation device 100 may include information indicating that heating of the aerosol source has been started. For example, when the inhalation device 100 starts heating the stick-type substrate 150, the inhalation device transmits information indicating the start of heating to the terminal device 200. In this case, the terminal device 200 sets the evaluation period on the basis of the time elapsed since the start of heating of the aerosol source. For example, the terminal device 200 sets a plurality of puff timings within a puffing-possible period, and determines the arrival of the set puff timing on the basis of an elapsed time from the start of heating the stick-type substrate 150. Then, the terminal device 200 sets an evaluation period corresponding to the arrived puff timing. According to such a configuration, it is possible to appropriately set the evaluation period.

The information regarding generation of the aerosol that the terminal device 200 acquires from the inhalation device 100 may include information (hereinafter also referred to as profile ID) for identifying the heating profile used by the inhalation device 100. For example, when the inhalation device 100 starts heating the stick-type substrate 150, the inhalation device transmits the profile ID of the heating profile used during heating to the terminal device 200. In this case, the terminal device 200 sets the evaluation period on the basis of the profile ID. The duration of the heating session, the duration from the start of heating to the start of the puffing-possible period, and the puff timing may vary for each heating profile. In this regard, according to such a configuration, it is possible to appropriately set the evaluation period.

The information regarding generation of the aerosol that the terminal device 200 acquires from the inhalation device 100 may include information indicating that the aerosol generated by the inhalation device 100 has been inhaled. For example, when the inhalation device 100 detects that the user has inhaled (or namely, puffed) the aerosol, the inhalation device transmits information indicating that the puff has been performed to the terminal device 200. Note that the inhalation device 100 determines that the puff has been performed when the sensor unit 112 has acquired a value associated with inhalation by the user. In this case, the terminal device 200 may set the evaluation period after the timing when the puff was performed. With such a configuration, the terminal device 200 can set the evaluation period and receive the setting of the evaluation of the smoking taste only when the puff has actually been performed near the puff timing.

The terminal device 200 may notify the user of information indicating that the timing to inhale the aerosol generated by the inhalation device 100 has arrived. For example, the terminal device 200 vibrates or emits light at the puff timing. With such a configuration, the user can actually puff at the puff timing with reference to the notification from the terminal device 200 and set the evaluation of the smoking taste.

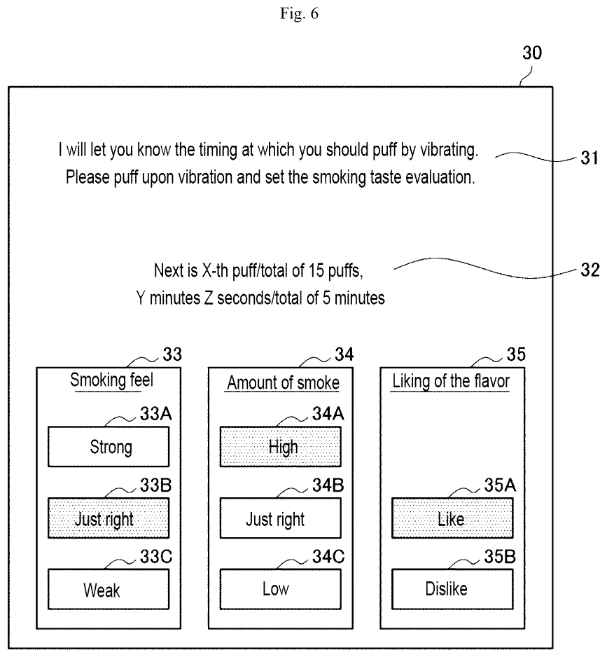

Here, an example of the UI screen displayed by the terminal device 200 will be described with reference to FIG. 6.

FIG. 6 is a diagram showing an example of a UI screen displayed by the terminal device 200 according to the embodiment. The terminal device 200 receives setting of the smoking taste evaluation on an evaluation setting screen 30. As shown in FIG. 6, the evaluation setting screen 30 includes an evaluation method explanation column 31, a progress display column 32, and evaluation setting columns 33-35.

The evaluation method explanation column 31 is a column for notifying the user of the evaluation method. The evaluation method explanation column 31 indicates that the terminal device 200 will vibrate when the timing at which the aerosol is to be inhaled has been reached. The user, referring to this explanation, may take a puff at the timing at which the vibration device 200 vibrates and set a smoking taste evaluation.

The progress display column 32 is a column for notifying the user of information indicating the progress in the process of aerosol generation by the inhalation device 100. The progress of the heating session is displayed in the top part of the progress display column 32, with the numerator being a number indicating which puff timing will come next, and the denominator being the total number of puff timings which have been set. The progress of the heating session is displayed in the bottom part of the progress display column 32, with the numerator being the time elapsed from the start of heating, and the denominator being the duration of the heating session. In the example shown in FIG. 6, the display of the progress display column 32 shows that that the X-th puff timing will come next out of a total of 15 puff timings, and that a 5-minute heating session has progressed up to Y minutes and Z seconds. The user can understand the progress of the heating session with reference to such a display.

The evaluation setting columns 33-35 are columns for receiving smoking taste evaluation settings by the user. The evaluation setting column 33 is a column for receiving settings for an evaluation in regard to smoking feel. The evaluation setting column 34 is a column for accepting settings for an evaluation in regard to the amount of smoke. The evaluation setting column 35 is a column for receiving settings for an evaluation in regard to liking for the flavor.

The evaluation setting column 33 for smoking feel includes buttons 33A-33C constituting UI elements for setting the evaluation in regard to smoking feel. The terminal device 200 receives: an evaluation setting that the smoking feel is strong when the button 33A is selected, an evaluation setting that the smoking feel is “just right” when the button 33B is selected, and an evaluation setting that the smoking feel is weak when the button 33C is selected.

The evaluation setting column 34 for amount of smoke includes buttons 34A-34C constituting UI elements for setting the evaluation in regard to the amount of smoke. The terminal device 200 receives: an evaluation setting that the amount of smoke is large when the button 34A is selected, an evaluation setting that the amount of smoke is “just right” when the button 34B is selected, and an evaluation setting that the amount of smoke is small when the button 34C is selected.

The evaluation setting column 35 for liking for the flavor includes buttons 35A and 35B constituting UI elements for setting the evaluation in regard to liking for the flavor. The terminal device 200 receives: an evaluation setting that the user likes the flavor when the button 35A is selected, and an evaluation setting that the user dislikes the flavor when the button 35B is selected.

The terminal device 200 receives settings for the smoking taste evaluation for a plurality of evaluation items in one evaluation period. For example, the terminal device 200 receives, each time a puff timing is reached, evaluation settings for smoking feel, amount of smoke and liking for the flavor in the evaluation period set in accordance with the puff timing which has been reached. In the example shown in FIG. 6, buttons 33B, 34A and 35A are respectively selected as smoking taste evaluations at the X-th puff timing. That is, the user sets an evaluation that the smoking feel is “just right”, the amount of smoke is large, and the user likes the flavor. By virtue of this feature, the user can set smoking taste evaluations from a number of perspectives.

The terminal device 200 notifies the user of information indicating the smoking taste evaluation which has been set. In the example shown in FIG. 6, the terminal device 200 displays the buttons 33B, 34A, and 35A selected by the user in a different form to the other buttons. As an example, the terminal device 200 may display the buttons selected by the user in a different color from other buttons. By virtue of this feature, the user can check the smoking taste evaluation which he or she has set.

An example of the UI screen displayed on the terminal device 200 was described above.

The terminal device 200 stores information (hereinafter also referred to as evaluation result information) indicating the smoking taste evaluation which has been set. The evaluation result information includes evaluation of the smoking taste for each puff timing. An example of the evaluation result information is shown in Table 1 below.

TABLE 1
Table 1. One example of evaluation result information

| | First | Second | Third | Fourth | |
|---|---|---|---|---|---|
| | puff | puff | puff | puff | . . . |
| Smoking feel | Strong | Strong | Just right | Weak | . . . |
| Amount of smoke | High | Just right | Just right | Low | . . . |
| Liking of the flavor | Like | Like | Like | Dislike | . . . |

The terminal device 200 may notify the user of the evaluation result information. For example, the terminal device 200 may display the table shown in Table 1. According to such a configuration, the user can collectively check the smoking taste evaluation which he or she has set during the heating session.

The terminal device 200 stores a combination of identification information for identifying the heating profile used by the inhalation device 100 and information indicating the evaluation for the smoking taste which has been set. More simply, the terminal device 200 stores evaluation result information in association with the profile ID. According to such a configuration, it is possible to accumulate evaluation result information for each heating profile.

The terminal device 200 transmits the stored evaluation result information to the server 300. In particular, the terminal device 200 transmits a combination of the profile ID and the evaluation result information to the server 300. For example, the terminal device 200 transmits evaluation result information to the server 300 at any timing such as a predetermined cycle or the timing at which a predetermined number of pieces of evaluation result information are accumulated. With such a configuration, the server 300 can aggregate the collected evaluation result information and utilize the information to improve the heating profile or substrate.

### (3) Aggregation of Smoking Taste Evaluations

The server 300 (e.g., control unit 330) receives and stores the evaluation result information, and controls processing for aggregating the stored evaluation result information. For example, the server 300 aggregates evaluation result information for each of the puff timings and evaluation items. The server 300 can calculate an average value, a weighted average value, or a median value of the puff timing and evaluation for each evaluation item, as aggregation results.

In particular, the server 300 aggregates a plurality of pieces of evaluation result information including evaluations of smoking taste set by the user for the aerosol generated on the basis of the same heating profile. For example, the server 300 aggregates evaluation result information associated with the same profile ID. According to such a configuration, it is possible to ascertain the trend of evaluation of smoking taste for each heating profile. The aggregation results may be utilized to improve the heating profile.

The server 300 may aggregate a plurality of pieces of evaluation result information including evaluations of the smoking taste set by a plurality of users. For example, the server 300 aggregates evaluation result information associated with the same profile ID that has been collected from a plurality of users. According to such a configuration, it is possible to ascertain the trend of evaluation of the smoking taste of the entire plurality of users.

An example of the aggregation method is shown in Table 2 below.

TABLE 2
Table 2. One example of aggregating
evaluations in regard to smoking feel

| | First puff | Second puff | Third puff | Fourth puff | . . . |
|---|---|---|---|---|---|
| User A | Strong | Strong | Just right | Weak | . . . |
| User B | High | Just right | Just right | Low | . . . |
| User C | Like | Like | Like | Dislike | . . . |
| . . . | . . . | . . . | . . . | . . . | . . . |
| Average | Strong | Slightly strong | Just right | Weak | |

As shown in Table 2, the server 300 may average the evaluations of the smoking taste set by the plurality of users for each of the puff timings and evaluation items.

### (4) Processing Flow

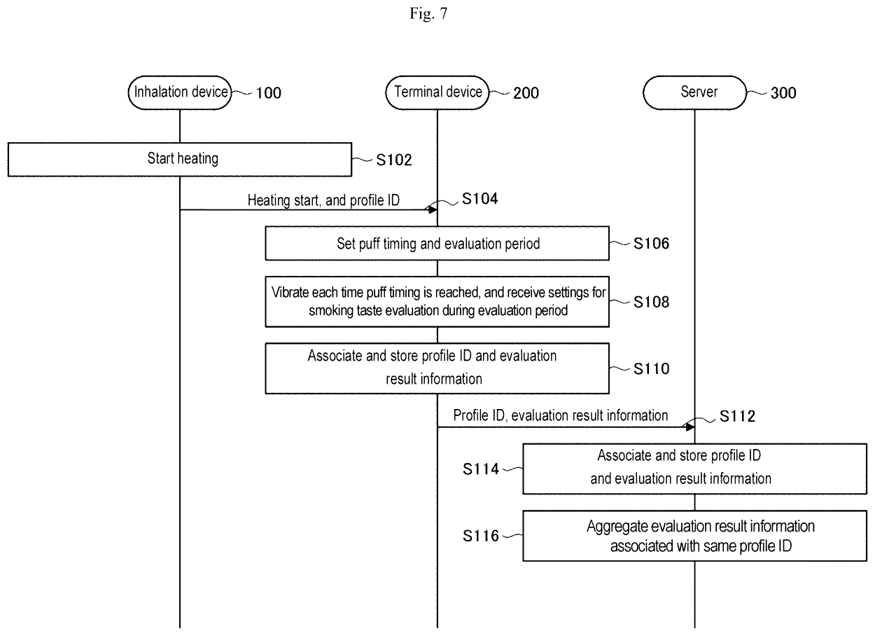

FIG. 7 is a sequence chart showing an example of a processing flow implemented by the system 1 according to the present embodiment. The present flow involves the inhalation device 100, the terminal device 200, and the server 300.

As shown in FIG. 7, the inhalation device 100 first of all starts heating of the stick-type substrate 150 based on the heating profile (step S102). For example, the inhalation device 100 starts heating when having detected that the stick-type substrate 150 has been inserted or a predetermined button has been depressed.

Next, the inhalation device 100 transmits information indicating the start of heating and a profile ID of the heating profile used for heating to the terminal device 200 (step S104).

Upon receiving the information indicating the start of heating and the profile ID, the terminal device 200 sets a puff timing and an evaluation period (step S106). For example, the terminal device 200 sets a plurality of puff timings on the basis of the profile ID and an elapsed time from the start of heating, and sets a plurality of evaluation periods corresponding to the plurality of puff timings.

Next, the terminal device 200 vibrates each time the puff timing arrives, and receives settings for evaluation of the smoking taste during the evaluation period (step S108). For example, while displaying the evaluation setting screen shown in FIG. 6, the terminal device 200 vibrates each time the puff timing arrives, and receives settings for the evaluation of the smoking taste.

Next, the terminal device 200 stores the profile ID and evaluation result information in association with each other (step S110).

The terminal device 200 then transmits the stored profile ID and evaluation result information to the server 300 (step S112).

When the server 300 receives the profile ID and evaluation result information, the server stores the received profile ID and evaluation result information in association with each other (step S114).

Then, the server 300 aggregates evaluation result information associated with the same profile ID (step S116).

### 3. Supplementary Information

Although preferred embodiments of the present disclosure have been described in detail above with reference to the accompanying drawings, the present disclosure is not limited to such examples. It is obvious that a person having an ordinary level of knowledge in the technical field to which the present disclosure belongs could conceive of various modified examples or variations within the scope of the technical concepts set forth in the claims, and these modified examples and variations will naturally be understood to fall within the technical scope of the present disclosure.

In the above embodiments, an example has been described in which the terminal device 200 sets the evaluation period on the basis of information regarding generation of the aerosol acquired from the inhalation device 100, but the present disclosure is not limited to such an example. For example, the terminal device 200 may set the evaluation period in accordance with the interval of the puffs that the user has performed in the past. According to such a configuration, it is possible to set an evaluation period suitable for the habits of the user, such as a narrow or wide puff interval.

Although the above embodiment has described an example in which the terminal device 200 sets the puff timing and sets the evaluation period corresponding to the set puff timing, the present disclosure is not limited to such an example. For example, the terminal device 200 need not set the puff timing in advance, and may set the evaluation period immediately after receiving information indicating that the puff has been performed from the inhalation device 100. According to such a configuration, the user can freely set the evaluation of the smoking taste while puffs are performed at any timing. In this case, the server 300 can aggregate evaluation result information with similar timing to when the puffs were made.

While the above embodiment described an example in which a discrete evaluation, such as a strong, just right, or weak is set as an evaluation of the smoking taste, the present disclosure is not limited to such examples. For example, the terminal device 200 may receive an evaluation as a continuous value from 0 to 100. In this case, it is possible to more easily aggregate the evaluation of the smoking taste by the server 300.

Although the above embodiment has described an example of aggregating the evaluation result information collected from a plurality of users, the evaluation result information to be aggregated may be selected as appropriate.

As an example, the server 300 may aggregate a plurality of pieces of evaluation result information including evaluations of the smoking taste set by a plurality of users belonging to a prescribed user group. User groups can be classified based on attributes such as age and gender. For example, the terminal device 200 associates information indicating the attribute of the user with the evaluation result information and transmits the same to the server 300. Then, the server 300 may aggregate the evaluation result information associated with the same user's attributes. According to such a configuration, it is possible to ascertain the trend of evaluation of smoking taste for each user attribute.

As another example, the server 300 may aggregate a plurality of pieces of evaluation result information including evaluations of the smoking taste set in a prescribed environment. The environment here refers to an environment in which the user puffs and sets an evaluation of the smoking taste. Examples of the environment include temperature, weather, humidity, location, country, etc. For example, the terminal device 200 associates information indicating the environment with the evaluation result information and transmits the same to the server 300. Then, the server 300 may aggregate the evaluation result information associated with the same environment. According to such a configuration, it is possible to ascertain the trend of evaluation of smoking taste for each environment.

As another example, the server 300 aggregates a plurality of pieces of evaluation result information including evaluations of smoking taste set by the user for the aerosol generated using a stick-type substrate 150 of the same type. For example, the inhalation device 100 identifies the type of stick-type substrate 150 to be heated, and transmits identification information about the stick-type substrate 150 (hereinafter also referred to as the stick ID) to the terminal device 200. The terminal device 200 associates the stick ID with the evaluation result information and transmits the same to the server 300. Then, the server 300 aggregates the evaluation result information associated with the same stick ID. According to such a configuration, it is possible to ascertain the trend of evaluation of smoking taste for each type of stick-type substrate 150.

The embodiments above described an example in which a parameter relating to the temperature at which the aerosol source is heated, as defined in the heating profile, is the target temperature of the heating units 121, but the present disclosure is not limited to such an example. The electrical resistance value of the heating units 121 may be cited as a parameter relating to the temperature at which the aerosol source is heated, in addition to the actual temperature of the heating units 121 described in the embodiment above. Furthermore, when the means for heating the aerosol source is induction heating, a target value such as the temperature of a susceptor or the electrical resistance value of an electromagnetic induction source may be cited as a parameter relating to the temperature at which the aerosol source is heated, as defined in the heating profile.

The embodiment above described an example in which the inhalation device 100 generates the aerosol by heating the stick-type substrate 150, but the present disclosure is not limited to such an example. The inhalation device 100 may equally be configured as what is known as a liquid atomization aerosol-generating device, which generates an aerosol by heating and atomizing a liquid aerosol source. The features of the present disclosure may also be applied to a liquid atomization aerosol-generating device.

As described in the embodiments above, settings for the smoking taste evaluation are received by the terminal device 200. Here, the terminal device 200 receiving the settings for the smoking taste evaluation may also refer to the settings for the smoking taste evaluation being received via a native application installed on the terminal device 200. Furthermore, the terminal device 200 receiving the settings for the smoking taste evaluation may also refer to receiving settings for the smoking taste evaluation via PWA (progressive web apps) provided for the terminal device 200. As an example, the server 300 may accept settings for the smoking taste evaluation via the PWA provided for the terminal device 200.

It should be noted that the series of processes performed by each device described in the present description may be realized by using software, hardware, and any combination of software and hardware. Programs constituting the software are prestored on a recording medium (more specifically, a non-transitory computer-readable storage medium) provided internally or externally to each device, for example. When the programs are then executed, for example, by a computer for controlling each device described in the present description, the programs are read into a RAM and executed by means of a processing circuit such as a CPU. The recording medium is, for example, a magnetic disk, an optical disk, a magneto-optical disk, or a flash memory, etc. Furthermore, the computer programs may be distributed via a network, for example, without the use of a recording medium. Furthermore, the computer may be an application-specific integrated circuit such as ASIC, a general-purpose processor which executes functions by reading software programs, or a computer on a server used for cloud computing, etc. Furthermore, the series of processes performed by each device described in the present description may be processed in a distributed manner by multiple computers.

Furthermore, the processing described using flowcharts and sequence diagrams in the present description need not necessarily be implemented in the order depicted. Some processing steps may be implemented in parallel. Furthermore, additional processing steps may be employed and some processing steps may be omitted.

It should be noted that configurations such as the following also fall within the technical scope of the present disclosure.

(1)

A terminal device comprising a control unit that controls processing for: setting, on the basis of information regarding generation of an aerosol acquired from an inhalation device that heats an aerosol source contained in a substrate to generate an aerosol, an evaluation period during which a smoking taste evaluation for the aerosol generated by the inhalation device can be set; and receiving the setting for smoking taste evaluation by a user during the evaluation period which has been set.

(2)

The terminal device according to (1), wherein the control unit sets the evaluation period within a period during which the inhalation device generates the aerosol by using one of the substrates.

(3)

The terminal device according to claim (1) or (2), wherein the control unit sets a plurality of the evaluation periods, and
each of the plurality of evaluation periods corresponds to each of a plurality of timings at which the aerosol generated by the inhalation device is inhaled by the user.
   (4)

The terminal device according to any one of (1)-(3), wherein the inhalation device heats the aerosol source on the basis of control information defining a parameter relating to a temperature at which the aerosol source is heated, and
the information regarding generation of the aerosol includes information for identifying the control information used by the inhalation device.
   (5)

The terminal device according to (4), wherein the control unit controls processing for storing a combination of information for identifying the control information used by the inhalation device and information indicating a smoking taste evaluation which has been set.

(6)

The terminal device according to any one of (1)-(5), wherein the information regarding generation of the aerosol includes information indicating that heating of the aerosol source has been started, and
the control unit sets the evaluation period on the basis of time elapsed since the start of heating of the aerosol source.
   (7)

The terminal device according to any one of (1)-(6), wherein the control unit controls processing for notifying the user of information indicating that the timing to inhale the aerosol generated by the inhalation device has been reached.

(8)

The terminal device according to any one of (1)-(7), wherein the information regarding generation of the aerosol includes information indicating that the aerosol generated by the inhalation device has been inhaled, and
the control unit sets the evaluation period after a timing at which the aerosol generated by the inhalation device has been inhaled.
   (9)

The terminal device according to any one of (1)-(8), wherein the control unit controls processing for notifying the user of information indicating the progress of processing in which the inhalation device generates the aerosol.

(10)

The terminal device according to any one of (1)-(9), wherein the control unit receives the setting for the smoking taste evaluation for a plurality of evaluation items in one of the evaluation periods.

(11)

The terminal device according to any one of (1)-(10), wherein the control unit controls processing for notifying the user of information indicating a smoking taste evaluation which has been set.

(12)

An information processing device comprising: a communication unit that receives evaluation result information including a smoking taste evaluation set by a user for an aerosol generated by an inhalation device heating an aerosol source contained in a substrate on the basis of control information defining a parameter relating to a temperature at which the aerosol source is heated; and
a control unit that aggregates a plurality of pieces of the evaluation result information including smoking taste evaluations set by the user for the aerosol generated on the basis of the same control information, received by the communication unit.
   (13)

The information processing device according to (12), wherein the control unit aggregates a plurality of pieces of the evaluation result information including smoking taste evaluations set by a plurality of users.

(14)

The information processing device according to (13), wherein the control unit aggregates a plurality of pieces of the evaluation result information including smoking taste evaluations set by a plurality of users belonging to a prescribed user group or set in a prescribed environment.

(15)

The information processing device according to any one of (12)-(14), wherein the control unit aggregates a plurality of pieces of the evaluation result information including smoking taste evaluations set by the user for the aerosol generated by using the same type of substrate.

### REFERENCE SIGNS LIST

1 System
100 Inhalation device
111 Power source unit
112 Sensor unit
113 Notification unit
114 Memory unit
115 Communication unit
116 Control unit
121 Heating unit
140 Accommodating portion
141 Internal space
142 Opening
143 Bottom portion
144 Heat insulating portion
150 Stick-type substrate
151 Substrate portion
152 Mouthpiece portion
200 Terminal device
210 Input unit
220 Output unit
230 Detection unit
240 Communication unit
250 Memory unit
260 Control unit
300 Server
310 Communication unit
320 Memory unit
330 Control unit
900 Network

1. A terminal device comprising:
circuitry configured to
control reception of first information regarding generation of an aerosol from an inhalation device that heats an aerosol source contained in a substrate to generate the aerosol,
set, based on the first information, an evaluation period for a smoking taste evaluation for the aerosol generated by the inhalation device,
provide a User Interface (UI) for the smoking taste evaluation to a user of the inhalation device, based on the evaluation period which has been set, and
control reception of second information indicating the smoking taste evaluation by the user of the inhalation device via the UI, during the evaluation period.

2. The terminal device according to claim 1, wherein the circuitry is configured to set the evaluation period within a period during which the inhalation device generates the aerosol by using the substrate.

3. The terminal device according to claim 1, wherein the circuitry is configured to set a plurality of evaluation periods, and
each of the plurality of evaluation periods corresponds to each of a plurality of timings at which the aerosol generated by the inhalation device is inhaled by the user.

4. The terminal device according to claim 1, wherein the inhalation device heats the aerosol source based on control information defining a parameter relating to a temperature at which the aerosol source is heated, and
the first information includes identification information for identifying the control information used by the inhalation device.

5. The terminal device according to claim 4, wherein the circuitry is configured to store a combination of the identification information for identifying the control information used by the inhalation device and the second information.

6. The terminal device according to claim 1, wherein the first information includes third information indicating that heating of the aerosol source has been started, and
the circuitry is configured to set the evaluation period based on time elapsed since start of heating of the aerosol source.

7. The terminal device according to claim 1, wherein the circuitry is configured to control notification to the user via the UI, the notification indicating that a timing to inhale the aerosol generated by the inhalation device has been reached.

8. The terminal device according to claim 1, wherein the first information includes fourth information indicating that the aerosol generated by the inhalation device has been inhaled, and
the circuitry is configured to set the evaluation period after a timing at which the aerosol generated by the inhalation device has been inhaled.

9. The terminal device according to claim 1, wherein the circuitry is configured to control notification to the user via the UI, the notification indicating progress of processing in which the inhalation device generates the aerosol.

10. The terminal device according to claim 1, wherein the circuitry is configured to control reception of the second information for the smoking taste evaluation for a plurality of evaluation items corresponding to the evaluation period.

11. The terminal device according to claim 1, wherein the circuitry is configured to output the second information to the user via the UI.

12. An information processing device comprising:
circuitry configured to
control reception of evaluation result information including a smoking taste evaluation acquired by a user for an aerosol generated by an inhalation device, the inhalation device heating an aerosol source contained in a substrate based on control information that defines a parameter relating to a temperature at which the aerosol source is heated, and
aggregate a plurality of pieces of the evaluation result information including smoking taste evaluations acquired by the user for the aerosol generated based on the same control information.

13. The information processing device according to claim 12, wherein the circuitry is configured to aggregate the plurality of pieces of the evaluation result information including smoking taste evaluations acquired by a plurality of users.

14. The information processing device according to claim 13, wherein the circuitry is configured to aggregate the plurality of pieces of the evaluation result information including smoking taste evaluations acquired by the plurality of users belonging to a first user group, or the plurality of pieces of the evaluation result information acquired in a first environment.

15. The information processing device according to claim 12, wherein the circuitry is configured to aggregate the plurality of pieces of the evaluation result information including smoking taste evaluations acquired by a plurality of users for the aerosol generated by using the same type of substrate.

16. The terminal device according to claim 7, further comprising
a vibrator,
wherein the circuitry is configured to control vibration of the vibrator under a condition that the timing to inhale the aerosol generated by the inhalation device has been reached.

17. The terminal device according to claim 10, wherein the plurality of evaluation items includes at least one of smoking strongness information, smoke amount information, or flavor likeness information, evaluated by the user of the inhalation device.

18. The information processing device according to claim 14, wherein the first user group is defined by at least one of age or classification of sex of the plurality of users.

19. The information processing device according to claim 14, wherein the first environment is defined by at least one of temperature, weather, humidity, location, or country at which the inhalation device is used.

20. A non-transitory computer-readable storage medium including computer executable instructions, wherein the instructions, when executed by a terminal device, cause the terminal device to perform a method, the method comprising:
controlling reception of first information regarding generation of an aerosol from an inhalation device that heats an aerosol source contained in a substrate to generate the aerosol;
setting, based on the first information, an evaluation period for a smoking taste evaluation for the aerosol generated by the inhalation device;
providing a User Interface (UI) for the smoking taste evaluation to a user of the inhalation device, based on the evaluation period which has been set; and
controlling reception of second information indicating the smoking taste evaluation by the user of the inhalation device via the UI, during the evaluation period.
